(19) United States
(12) Patent Application Publication
(10) Pub. No.: US 2022/0215276 A1
(43) Pub. Date: Jul. 7, 2022

(54) ELECTRONIC DEVICE AND METHOD FOR CONTROLLING ELECTRONIC DEVICE

(71) Applicant: Samsung Electronics Co., Ltd., Suwon-si, Gyeonggi-do (KR)

(72) Inventors: Haejun LEE, Suwon-si (KR); Cheolseung JUNG, Suwon-si (KR)

(21) Appl. No.: 17/607,702

(22) PCT Filed: Aug. 12, 2020
(86) PCT No.: PCT/KR2020/010666

§ 371 Date: Oct. 29, 2021

(30) Foreign Application Priority Data
Nov. 29, 2019 (KR) 10-2019-0156907

(51) Int. Cl. G06N 5/04; G06N 3/08; G06F 16/903

(52) U.S. Cl. CPC G06N 5/04; G06F 16/90335; G06N 3/08

(57) ABSTRACT

Disclosed are an electronic device and a method for controlling an electronic device. The electronic device according to the disclosure obtains text information corresponding to a user's question, obtains a plurality of keywords related to the user's question and importance values for the respective keywords by inputting the text information corresponding to the user's question to a trained first neural network model, identifies at least one search word to be input to a search engine among the plurality of keywords by inputting the plurality of keywords and the importance values to a trained second neural network model, and provides an answer to the user's question based on the at least one identified search word.

### TECHNICAL FIELD

The disclosure relates to an electronic device and a method for controlling an electronic device, and more particularly relates to an electronic device capable of obtaining a search result including an answer to a user's question and a method for controlling the same.

### BACKGROUND ART

In recent years, development of technologies in artificial intelligence (AI) assistant field has been accelerated, and a question answering technology for providing an accurate answer to a user's question is receiving attention.

As examples of the question answering technology, technologies such as knowledge based question answering (KBQA) that grasps meaning of a point of a user's question and asks this question to a pre-constructed knowledge graph storage to search for an answer, information retrieval question answering (IRQA) that constructs predicted question-answer data in advance, when the user's question is received, searches for a question similar to the received question, and provides an answer to the question, and machine reading comprehension question answering (MCRQA) that obtains a search word from the received question, searches for a related document, and obtains and provides an answer from the document have been developed.

However, according to the technologies developed so far, when there is a low probability of searching for a document including an answer to a user's question, in a case where a sentence included in the user's question is input to a search engine as it is, such as a case where the user inputs a question with a colloquial sentence or inputs a question with too long sentence, it is difficult to provide an answer corresponding to intent of the user's question.

Therefore, there is a need for a technology of obtaining a search word capable of searching for a document including an answer to a user's question based on an input sentence, even when there is a low probability of searching for a document including an answer to the user's question, in a case where a sentence included in a user's question is input to a search engine as it is, and searching for the document including the answer to the user's question based on the obtained search word to provide an answer corresponding to the intent of the user's question.

### DISCLOSURE

### Technical Problem

The disclosure is made in view of the needs described above, and an object of the disclosure is to provide an electronic device capable of identifying a search word to be input to a search engine based on a user's question and obtaining a search result including an answer to the user's question based on the identified search word, and a method for controlling the same.

### Technical Solution

In accordance with an aspect of the disclosure, there is provided an electronic device including a memory storing at least one instruction, and a processor configured to execute the at least one instruction, in which the processor, by executing the at least one instruction, is configured to obtain text information corresponding to a user's question, obtain a plurality of keywords related to the user's question and importance values for the respective keywords by inputting the text information corresponding to the user's question to a trained first neural network model, identify at least one search word to be input to a search engine among the plurality of keywords by inputting the plurality of keywords and the importance values to a trained second neural network model, and provide an answer to the user's question based on the at least one identified search word.

The first neural network model may be configured to obtain the plurality of keywords and the importance values based on a database including a plurality of questions and answers to the plurality of questions, and the plurality of keywords may include a first word included in the text information corresponding to the user's question and a second word not included in the text information corresponding to the user's question.

The second word may be a word positioned within a predetermined distance from the first word among the plurality of words included in the database.

The second neural network model may be configured to identify a number of keywords to be included in the at least one search word among the plurality of keywords, and identify the at least one keyword among the plurality of keywords according to the identified number.

The second neural network model may be configured to arrange the plurality of keywords according to an order of the importance values, and identify the number of keywords by identifying a keyword having a lowest importance value among at least one keyword to be included in the at least one search word through a pointer network included in the second neural network model.

The electronic device may further include a microphone, and the processor may be configured to, based on a voice signal corresponding to the user's question being received through the microphone, obtain text information corresponding to the user's question based on the voice signal.

The electronic device may further include a communicator including circuitry, and the processor may be configured to control the communicator to transmit information on the at least one identified search word to a server for providing the search engine, receive a search result for the at least one identified search word from the server via the communicator, and provide an answer to the user's question based on the received search result.

At least one of the first neural network model and the second neural network model may be trained based on the received search result.

The search result may include a plurality of documents arranged according to a search order, and at least one of the first neural network model and the second neural network model may be subjected to reinforcement learning based on whether the answer to the user's question is included in at least one document of the plurality of documents, and the search order of the at least one document.

An entire pipeline of the first neural network model and the second neural network model may be subjected to reinforcement learning by an end-to-end method.

In accordance with another aspect of the disclosure, there is provided a method for controlling an electronic device, the method including obtaining text information corresponding to a user's question, obtaining a plurality of keywords related to the user's question and importance values for the respective keywords by inputting the text information corresponding to the user's question to a trained first neural network model, identifying at least one search word to be input to a search engine among the plurality of keywords by inputting the plurality of keywords and the importance values to a trained second neural network model, and providing an answer to the user's question based on the at least one identified search word.

The first neural network model may be configured to obtain the plurality of keywords and the importance values based on a database including a plurality of questions and answers to the plurality of questions, and the plurality of keywords may include a first word included in the text information corresponding to the user's question and a second word not included in the text information corresponding to the user's question.

The second word may be a word positioned within a predetermined distance from the first word among the plurality of words included in the database.

The second neural network model may be configured to identify a number of keywords to be included in the at least one search word among the plurality of keywords, and identify the at least one search word among the plurality of keywords according to the identified number.

The second neural network model may be configured to arrange the plurality of keywords according to an order of the importance values, and identify the number of keywords by identifying a keyword having a lowest importance value among at least one keyword to be included in the at least one search word through a pointer network included in the second neural network model.

The obtaining the text information corresponding to the user's question may include receiving a voice signal corresponding to the user's question, and obtaining text information corresponding to the user's question based on the voice signal.

The providing the answer to the user's question may include transmitting information on the at least one identified search word to a server for providing the search engine, receiving a search result for the at least one identified search word from the server, and providing an answer to the user's question based on the received search result.

At least one of the first neural network model and the second neural network model may be trained based on the received search result.

The search result may include a plurality of documents arranged according to a search order, and at least one of the first neural network model and the second neural network model may be subjected to reinforcement learning based on whether the answer to the user's question is included in at least one document of the plurality of documents, and the search order of the at least one document.

In accordance with another aspect of the disclosure, there is provided a computer-readable recording medium including a program for executing a method for controlling an electronic device, the method including obtaining text information corresponding to a user's question, obtaining a plurality of keywords related to the user's question and importance values for the respective keywords by inputting the text information corresponding to the user's question to a trained first neural network model, identifying at least one search word to be input to a search engine among the plurality of keywords by inputting the plurality of keywords and the importance values to a trained second neural network model, and providing an answer to the user's question based on the at least one identified search word.

### DESCRIPTION OF DRAWINGS

FIG. 1 is a conceptual diagram schematically illustrating a processing process of a question and an answer according to an embodiment;

FIG. 2A is a block diagram schematically illustrating a configuration of an electronic device according to an embodiment;

FIG. 2B is a block diagram specifically illustrating the configuration of the electronic device according to an embodiment;

FIG. 3A is a diagram specifically illustrating a sequential processing process of a first neural network model, a second neural network model, and a search engine according to an embodiment;

FIG. 3B is a diagram more specifically illustrating an embodiment based on a specific example of input values and output values for the first neural network model, the second neural network model, and the search engine;

FIG. 4 is a diagram specifically illustrating a process of, when a user's voice corresponding to a user's question is received, processing the received user's voice and inputting the user's voice to the first neural network model according to an embodiment;

FIG. 5 is a diagram specifically illustrating a processing process of the second neural network model according to an embodiment;

FIG. 6 is a diagram specifically illustrating a training process of the first neural network model and the second neural network model according to an embodiment; and

FIG. 7 is a flowchart illustrating a method for controlling the electronic device according to an embodiment.

### DETAILED DESCRIPTION OF EXEMPLARY EMBODIMENTS

The embodiments of the disclosure may be variously changed and include various embodiments, and specific embodiments will be shown in the drawings and described in detail in the description. However, it should be understood that this is not to limit the scope of the specific embodiments and all modifications, equivalents, and/or alternatives included in the disclosed spirit and technical scope are included. In relation to explanation of the drawings, similar reference numerals may be used for similar elements.

In describing the disclosure, a detailed description of the related art or configuration may be omitted when it is determined that the detailed description may unnecessarily obscure a gist of the disclosure.

In addition, the embodiments below may be changed in various forms and the scope of the technical idea of the disclosure is not limited to the embodiments below. The embodiments are provided to complete the disclosure and completely transfer the technical idea of the disclosure to those skilled in the art.

The terms used in the disclosure are merely used for describing specific embodiments and do not limit the scope of a right of the disclosure. In the disclosure, unless otherwise defined specifically, a singular expression may encompass a plural expression.

In this disclosure, the terms such as “comprise”, “may comprise”, “consist of”, or “may consist of” are used herein to designate a presence of corresponding features (e.g., constituent elements such as number, function, operation, or part), and not to preclude a presence of additional features.

In this disclosure, expressions such as “A or B”, “at least one of A [and/or] B,”, or “one or more of A [and/or] B,” include all possible combinations of the listed items. For example, “A or B”, “at least one of A and B,”, or “at least one of A or B” includes any of (1) at least one A, (2) at least one B, or (3) at least one A and at least one B.

The expressions “first,” “second” and the like used in the disclosure may denote various elements, regardless of order and/or importance, and may be used to distinguish one element from another, and does not limit the elements.

If it is described that a certain element (e.g., first element) is “operatively or communicatively coupled with/to” or is “connected to” another element (e.g., second element), it should be understood that the certain element may be connected to the other element directly or through still another element (e.g., third element).

On the other hand, if it is described that a certain element (e.g., first element) is “directly coupled to” or “directly connected to” another element (e.g., second element), it may be understood that there is no element (e.g., third element) between the certain element and the another element.

Also, the expression “configured to” used in the disclosure may be interchangeably used with other expressions such as “suitable for,” “having the capacity to,” “designed to,” “adapted to,” “made to,” and “capable of,” depending on cases. Meanwhile, the expression “configured to” does not necessarily refer to a device being “specifically designed to” in terms of hardware.

Instead, under some circumstances, the expression “a device configured to” may refer to the device being “capable of” performing an operation together with another device or component. For example, the phrase “a unit or a processor configured (or set) to perform A, B, and C” may refer, for example, and without limitation, to a dedicated processor (e.g., an embedded processor) for performing the corresponding operations, a generic-purpose processor (e.g., a central processing unit (CPU) or an application processor), or the like, that can perform the corresponding operations by executing one or more software programs stored in a memory device.

A term such as “module” or “unit” in the embodiment executes at least one function or operation and may be implemented as hardware, software, or a combination of hardware and software. Further, except for when a plurality of “modules”, “units”, and the like need to be realized in a specific hardware, the components may be integrated in at least one module and be implemented in at least one processor.

Meanwhile, various elements and areas in the drawings are schematically illustrated. Therefore, the technical spirit of the disclosure is not limited by comparative sizes or intervals illustrated in the accompanying drawings.

Hereinafter, with reference to the accompanying drawings, embodiments of the disclosure will be described in detail for those skilled in the art to easily practice the embodiments.

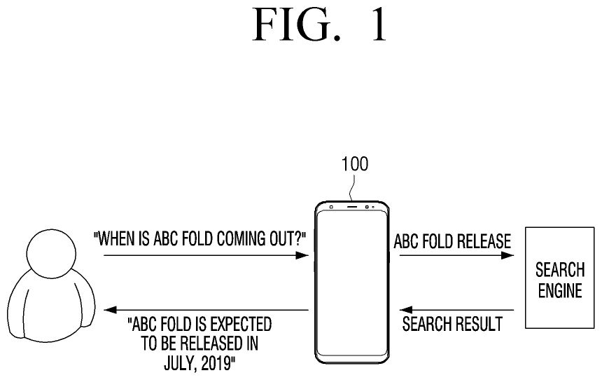

FIG. 1 is a conceptual diagram schematically illustrating a processing process of a question and an answer according to an embodiment.

An electronic device 100 according to the disclosure may obtain text information corresponding to a user's question. For example, referring to FIG. 1, the electronic device 100 may obtain text information corresponding to the user's question “When is ABC Fold coming out?”

Herein, the text information corresponding to the user's question may be not only the text information received by a text input of the user, but also text information obtained based on a voice signal received as a voice signal by user's utterance.

The electronic device 100 may obtain a search result related to the user's question through a search engine based on the text information corresponding to the user's question. However, the text information corresponding to the user's question may include not only words necessary to obtain the search result related to the user's question, but also unnecessary words.

Accordingly, rather than inputting the obtained text information to the search engine as it is, the electronic device 100 according to the disclosure may obtain at least one search word capable of increasing a probability of obtaining the search result including an answer to the user's question based on the text information corresponding to the user's question by using a first neural network model and a second neural network model, and obtain the search result related to the user's question by inputting the at least one obtained search word to the search engine. Herein, the first neural network model and the second neural network model may refer to artificial intelligence models including an artificial neural network, and therefore the neural network model may be used interchangeably with an artificial intelligence model.

Specifically, the electronic device 100 may input the text information corresponding to the user's question to the trained first neural network model to obtain a plurality of keywords related to the user's question and importance values for the respective keywords. The plurality of keywords may include not only a first word included in the text information corresponding to the user's question, but also a second word not included in the text information corresponding to the user's question. For example, although not illustrated in FIG. 1, the electronic device 100 may input the text information corresponding to the user's question “When is ABC Fold coming out?” to the first neural network model to obtain a plurality of keywords “ABC”, “Fold”, “release”, “announce”, and “expect” as the plurality of keywords related to the user's question and obtain importance values for the respective keywords.

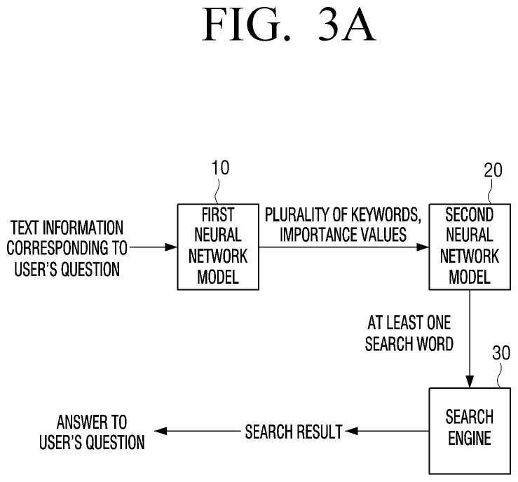

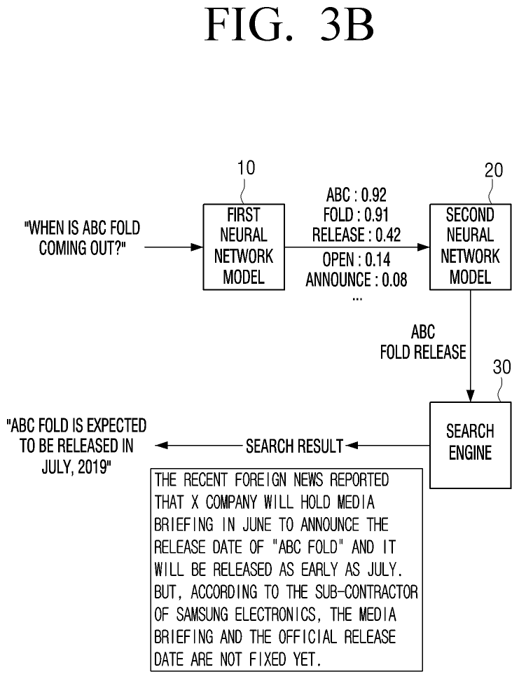

A specific process of obtaining the plurality of keywords and the importance values for the respective keywords through the first neural network model will be described below with reference to FIGS. 3A and 3B.

When the plurality of keywords and the importance values for the respective keywords are obtained, the electronic device 100 may input the plurality of keywords and the importance values to the trained second neural network model to identify at least one search word to be input to the search engine among the plurality of keywords. Specifically, the electronic device 100 may identify the number of keywords to be included in at least one search word among the plurality of keywords and identify at least one search word among the plurality of keywords according to the identified number through the second neural network model. For example, referring to FIG. 1, when the plurality of keywords “ABC”, “Fold”, “release”, “announce”, and “expect” and the importance values for the respective keywords are obtained, the electronic device 100 may identify three search words “ABC”, “Fold”, and “release” as at least one search word to be input to the search engine among the plurality of keywords.

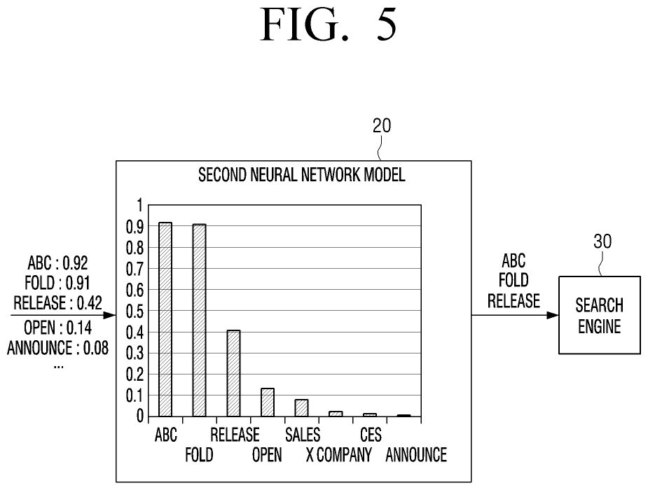

A specific process of identifying at least one search word to be input to the search engine among the plurality of keywords through the second neural network model will be described below with reference to FIGS. 3A, 3B, and 5.

When at least one search word is identified, the electronic device 100 may obtain the search result related to the user's question by inputting the at least one identified search word to the search engine, and provide an answer to the user's question based on the obtained search result. For example, when the three search words “ABC”, “Fold”, and “release” are identified, the electronic device 100 may obtain the search result related to the user's question by inputting the three identified search words to the search engine and provide an answer “ABC Fold will be released in July, 2019” based on the obtained search result.

As described above, the electronic device 100 according to the disclosure may obtain the plurality of keywords and the importance values for the respective keywords based on the text information corresponding to the user's question, identify at least one search word among the plurality of keywords, and obtain the search result based on the at least one identified search word, thereby providing an answer to the user's question with a high accuracy.

The above process may be similar to a process of selecting a plurality of keywords related to a question and selecting an appropriate number of search words therefrom, in a process of selecting at least one search word to be input to a search bar of a web page in order to obtain a search result including an answer to the user's question.

However, according to the disclosure, even if the user inputs a question with a low probability of searching for a document including an answer to the user's question, in a case where a sentence included in the user's question is input to the search engine as it is, the electronic device 100 may obtain a plurality of keywords capable of increasing a probability of obtaining a search result including an answer to the user's question by using the trained first neural network model, and identify an appropriate number of search words capable of increasing the probability of obtaining a search result including an answer to the user's question by using the trained second neural network model.

Accordingly, the user of the electronic device 100 may obtain the search result including the answer to the user's question without trial and error of repeating the process of confirming the search result, then selecting the plurality of keywords again to obtain the search result including the answer to the question, and selecting an appropriate number of search words therefrom.

In addition, as will be described below, at least one of the first neural network model and the second neural network model according to the disclosure may be subjected to reinforcement learning based on the search result obtained through the search engine, and accordingly, this may be considered as pre-training of a method for increasing a probability of obtaining the search result including the answer to the user's question by trial and error that the user may experience in the process of directly selecting the search words as described above.

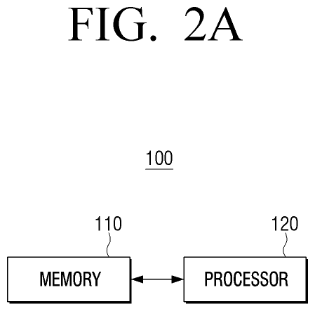

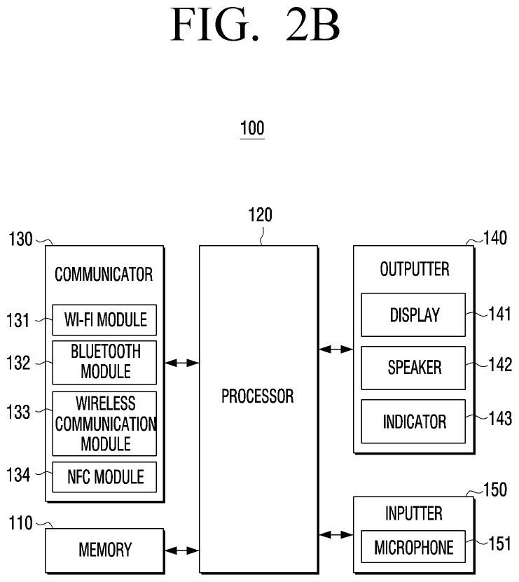

Hereinafter, various embodiments of the disclosure related to the processing process of the question and the answer as described above will be described with reference to FIGS. 2 to 7.

FIG. 2A is a block diagram schematically illustrating a configuration of the electronic device 100 according to an embodiment.

Referring to FIG. 2A, the electronic device 100 according to an embodiment of the disclosure may include a memory 110 and a processor 120.

The memory 110 may store at least one instruction for the electronic device 100. The memory 110 may store an operating system (O/S) for operating the electronic device 100. In addition, the memory 110 may store various software programs or applications for operating the electronic device 100 according to various embodiments of the disclosure. The memory 110 may include a semiconductor memory such as a flash memory or a magnetic storage medium such as a hard disk.

Specifically, the memory 110 may store various software modules for operating the electronic device 100 according to various embodiments of the disclosure, and the processor 120 may control the operations of the electronic device 100 by executing the various software modules stored in the memory 110. In other words, the memory 110 may be accessed by the processor 120 and reading, recording, editing, deleting, or updating of the data by the processor 120 may be executed.

A term, memory 110, in the disclosure may include the memory 110, a ROM (not illustrated) and a RAM (not illustrated) in the processor 120, or a memory card (not illustrated) (e.g., micro SD card or memory stick) mounted on the electronic device 100.

Particularly, in various embodiments of the disclosure, the memory 110 may store at least a part of data among data related to the first neural network model, the second neural network model, the search engine, an ASR model, and a word embedding model according to the disclosure. In addition, the memory 110 may store information such as the text information corresponding to the user's question, the plurality of keywords, the importance values for the respective keywords, at least one search word to be input to the search engine, and the like.

In addition, various pieces of information necessary in the range for achieving the object of the disclosure may be stored in the memory 110, and the information stored in the memory 110 may be received from a server or an external device or updated according to the input by the user.

The processor 120 may control general operations of the electronic device 100. Specifically, the processor 120 may be connected to constituent elements of the electronic device 100 including the memory 110 described above, and a communicator 130, an outputter 140, and an inputter 150 which will be described later, and may generally control the operations of the electronic device 100 by executing at least one instruction stored in the memory 110 described above.

The processor 120 may be implemented by various methods. For example, the processor 120 may be implemented as at least one of an application specific integrated circuit (ASIC), an embedded processor, a microprocessor, a hardware control logic, a hardware finite state machine (FSM), and a digital signal processor (DSP). Meanwhile, a term, the processor 120, in the disclosure may be used as meaning including a central processing unit (CPU), a graphic processing unit (GPU), and a main processing unit (MPU).

Particularly, in various embodiments according to the disclosure, the processor 120 may perform the processing process of the question and answer according to various embodiments of the disclosure. In other words, the processor 120 may obtain a plurality of keywords and importance values for the respective keywords based on text information corresponding to a user's question, identify at least one search word among the plurality of keywords, and obtain a search result based on the at least one identified search word to provide an answer to the user's question. Hereinafter, a control process of the processor 120 according to the disclosure will be described in more detail.

First, the first neural network model according to the disclosure may refer to a neural network model for outputting a plurality of keywords and importance values for the respective keywords. Specifically, the first neural network model may be trained based on a database including a plurality of questions and answers to the plurality of questions (hereinafter, referred to as a database).

When the text information corresponding to the user's question is obtained, the processor 120 may obtain a plurality of keywords and obtain importance values for the respective keywords together through the first neural network model.

The plurality of keywords may include not only the first word included in the text information corresponding to the user's question, but also the second word not included in the text information corresponding to the user's question. The second word may be a word positioned in a predetermined distance from the first word among the plurality of words included in the database. The predetermined distance may indicate by how many letters or words the second word is averagely spaced apart from the first word in the database, and a specific reference may change according to setting of the user.

More specifically, when the text information corresponding to the user's question is obtained, the processor 120 may obtain a word included in the database among words included in the text information as the first word through the first neural network model. The processor 120 may obtain a word which is not included in the text information corresponding to the user's question but is positioned within the predetermined distance from the first word among the plurality of words included in the database as the second word through the first neural network model.

For example, when text information corresponding to a user's question “When can I see XXX?” is input, the processor 120 may obtain a word “XXX” included in the database among words “When”, “can I”, “see”, and “XXX” as the first word among the plurality of keywords through the first neural network model. In addition, the processor 120 may obtain “movie”, “release”, and “domestic” which are not included in the text information corresponding to the user's question but positioned within the predetermined distance from “XXX” among the plurality of words included in the database as the second words through the first neural network model. In other words, when the text information corresponding to the user's question “When can I see XXX?” is input, the processor 120 may obtain the plurality of keywords “XXX”, “movie”, “release”, and “domestic” through the first neural network model.

Meanwhile, the processor 120 may obtain the importance values for the respective keywords based on frequencies that the plurality of keywords are respectively used in the database through the first neural network model. For example, the processor 120 may obtain “0.97”, “0.83”, “0.62” and “0.12” as the importance values for the respective keywords based on the frequencies that the plurality of keywords “XXX”, “movie”, “release”, and “domestic” are respectively used in the database through the first neural network model.

As described above, when the plurality of keywords and the importance values for the respective keywords are obtained, the processor 120 may output the plurality of keywords and the importance values for the respective keywords through the first neural network model and input these to the second neural network model.

The second neural network model according to the disclosure may refer to a neural network model for outputting at least one search word to be input to the search engine among the plurality of keywords. Specifically, the second neural network model may be trained based on the database described above.

The processor 120 may identify the number of keywords to be included in at least one search word among the plurality of keywords, and identify at least one search word among the plurality of keywords according to the identified number through the second neural network model. Particularly, through the second neural network model, the processor 120 may arrange the plurality of keywords according to the order of importance values, and identify the number of keywords by identifying a keyword having a lowest importance value among at least one keyword to be included in at least one search word through a pointer network included in the second neural network model.

For example, the plurality of keywords “XXX”, “movie”, “release”, and “domestic” are obtained and “0.88”, “0.83”, “0.42” and “0.12” are obtained as the importance values for the respective keywords, respectively, the processor 120 may arrange the plurality of keywords in the order of “XXX”, “movie”, “release”, and “domestic” according to the order of importance values through the second neural network model. The second neural network model may identify that “release” among the at least one keyword to be included in the at least one search word is a keyword having a lowest importance value, and identify that the number of the at least one keyword to be included in the at least one search word is three. Accordingly, “XXX”, “movie”, and “release” among the plurality of keywords may be identified as the at least one search word to be input to the search engine.

The process of identifying the number of keywords by identifying the keyword having a lowest importance value among the at least one keyword to be included in the at least one search word through the pointer network will be described below with reference to FIG. 5.

As described above, when the at least one search word to be input to the search engine is identified, the processor 120 may obtain a search result related to the user's question by inputting the identified search word to the search engine. When the search result related to the user's question is obtained, the processor 120 may provide an answer corresponding to the user's question based on the obtained search result.

For example, when the search result is obtained based on the at least one search word “XXX”, “movie”, and “release”, the processor 120 may provide an answer “Domestic release date of the movie XXX is Dec. 18, 2020” as the answer corresponding to the user's question based on the obtained search result.

FIG. 2B is a block diagram specifically illustrating the configuration of the electronic device 100 according to an embodiment.

Referring to FIG. 2B, the electronic device 100 according to an embodiment of the disclosure may further include the communicator 130, the outputter 140, and the inputter 150, in addition to the memory 110 and the processor 120. However, the above constituent elements are examples, and in practicing the disclosure, a new constituent element may be added to the above constituent elements or some constituent elements may be omitted. The memory 110 and the processor 120 have been described above with reference to FIG. 2A, and therefore, the communicator 130, the outputter 140, and the inputter 150 will be described below.

The communicator 130 may include circuitry and communicate with an external device. Specifically, the processor 120 may receive various pieces of data or information from an external device connected via the communicator 130 and transmit various pieces of data or information to the external device. Herein, the external device may include a server.

The communicator 130 may include at least one of a Wi-Fi module 131, a Bluetooth module 132, a wireless communication module 133, and an NFC module 134. Specifically, the Wi-Fi module 131 and the Bluetooth module 132 may perform communication by a Wi-Fi method and a Bluetooth method, respectively. When using the Wi-Fi module 131 or the Bluetooth module 132, various pieces of connection information such as SSID or the like may be transmitted or received first to allow the communication connection by using these, and then various pieces of information may be transmitted and received.

The wireless communication module 133 may perform communication based on various communication standards such as IEEE, Zigbee, 3rd Generation (3G), 3rd Generation Partnership Project (3GPP), Long Term Evolution (LTE), and 5th Generation (5G). The NFC module 134 may perform communication by a near field communication (NFC) method using a band of 13.56 MHz among various RF-ID frequency bands such as 135 kHz, 13.56 MHz, 433 MHz, 860 to 960 MHz, and 2.45 GHz.

Particularly, in various embodiments according to the disclosure, when at least one search word to be input to the search engine is identified, the processor 120 may control the communicator 130 to transmit the information on the at least one identified search word to the server which provides the search engine. The processor 120 may receive the search result for the at least one search word from the server via the communicator 130. When the search result is received from the server, the processor 120 may provide the answer to the user's question based on the received search result.

Meanwhile, in addition to the search engine, at least one of the ASR model, the word embedding model, the first neural network model, and the second neural network model according to the disclosure may be included in the external server of the electronic device 100. In this case, the processor 120 may establish communication connection with the server via the communicator 130 and transmit and receive various pieces of information and data according to the disclosure in the relationship with the server to implement various embodiments according to the disclosure.

For example, if the first neural network model is included in a first external server of the electronic device 100, the processor 120 may control the communicator 130 to transmit the text information corresponding to the user's question to the first server, and receive information on a plurality of keywords and importance values for the respective keywords from the first server via the communicator 130.

In addition, if the second neural network model is included in a second external server of the electronic device 100, the processor 120 may control the communicator 130 to transmit the information on the plurality of keywords and the importance values for the respective keywords to the second server, and receive information on at least one search word from the second server via the communicator 130.

The outputter 140 may include circuitry and the processor 120 may output various functions capable of being performed by the electronic device 100 via the outputter 140. In addition, the outputter 140 may include at least one of a display 141, a speaker 142, and an indicator 143.

The display 141 may output video data by the control of the processor 120. Specifically, the display 141 may output a video pre-stored in the memory 110 by the control of the processor 120.

Particularly, the display 141 according to an embodiment of the disclosure may display a user interface stored in the memory 110. The display 141 may be implemented as a liquid crystal display panel (LCD), organic light emitting diodes (OLED), or the like, and the display 141 may also be implemented as a flexible display, a transparent display, or the like, in some cases. However, the display 141 according to the disclosure is not limited to the specific type.

The speaker 142 may output audio data by the control of the processor 120 and the indicator 143 may be turned on by the control of the processor 120.

Particularly, in various embodiments of the disclosure, when information on the answer to the user's question is obtained based on the search result related to the user's question, the processor 120 may provide the answer to the user's question via the outputter 140. Specifically, the processor 120 may provide the answer to the user's question in a form of visual information via the display 141, or may provide the answer to the user's question in a form of a voice signal via the speaker 142.

The inputter 150 may include circuitry and the processor 120 may receive a user command for controlling the operations of the electronic device 100 via the inputter 150. Specifically, the inputter 150 may be formed of constituent elements such as a microphone 151, a camera (not illustrated), a remote control signal receiver (not illustrated), and the like. In addition, the inputter 150 may also be implemented to be included in the display as a touch screen.

Particularly, in various embodiments according to the disclosure, the inputter 150 may receive the text information corresponding to the user's question. Specifically, the inputter 150 may receive an input of a text of the user corresponding to the user's question and receive a voice signal corresponding to the user's question.

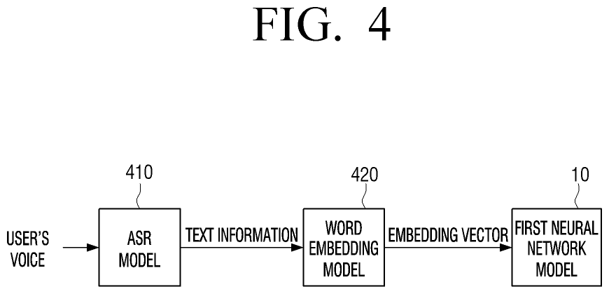

Particularly, the microphone 151 may receive a voice signal corresponding to the user's question. In addition, the obtained voice signal may be converted into a digital signal and stored in the memory 110. The microphone 151 may include an analogue-to-digital (A/D) converter, and may operate in association with the A/D converter located outside of the microphone 151. When the voice signal corresponding to the user's question is input, the processor 120 may obtain text information corresponding to the voice signal through an automatic speech recognition (ASR) model. The processing process of the ASR model will be described with reference to FIG. 4.

FIG. 3A is a diagram specifically illustrating a sequential processing process of the first neural network model 10, the second neural network model 20, and the search engine 30 according to an embodiment, and FIG. 3B is a diagram more specifically illustrating an embodiment according to the disclosure based on a specific example of input values and output values for the first neural network model 10, the second neural network model 20, and the search engine 30.

Referring to FIGS. 3A and 3B, when the text information corresponding to the user's question is input, a search result related to the user's question may be obtained through the processing process of each of the first neural network model 10, the second neural network model 20, and the search engine 30. The electronic device 100 may provide the answer to the user's question based on the obtained search result.

The first neural network model 10 according to the disclosure may refer to a neural network model for outputting a plurality of keywords and importance values for the respective keywords. The first neural network model 10 may include a neural network such as a recurrent neural network (RNN), but the structure of the first neural network model 10 according to the disclosure is not particularly limited.

Specifically, the first neural network model 10 may be trained based on a database including a plurality of questions and answers to the plurality of questions (hereinafter, referred to as a database). When the text information corresponding to the user's question is input, the first neural network model 10 may obtain a plurality of keywords based on the database used for training and obtain importance values corresponding the respective keywords together.

The plurality of keywords may include not only the first word included in the text information corresponding to the user's question, but also the second word which is not included in the text information corresponding to the user's question. The second word may be a word positioned in a predetermined distance from the first word among the plurality of words included in the database. The predetermined distance may indicate by how many letters or words the second word is averagely spaced apart from the first word in the database, and a specific reference may be changed according to setting of the user.

More specifically, when the text information corresponding to the user's question is input, the first neural network model 10 may obtain a word included in the database among words included in the input text information as the first word. The first neural network model 10 may obtain a word which is not included in the text information corresponding to the user's question but is positioned within the predetermined distance from the first word among the plurality of words included in the database as the second word.

For example, if the text information corresponding to the user's question “When is ABC Fold coming out?” is input, the first neural network model 10 may obtain words “ABC” and “Fold” which are included in the database among words “When is”, “ABC”, “Fold”, and “coming out”, as the first words among the plurality of keywords. In addition, the first neural network model 10 may obtain “release”, “announce”, and “expect” which are words not included in the text information corresponding to the user's question but positioned within the predetermined distance from “ABC” and “Fold” among the plurality of words included in the database as the second words. In other words, referring to FIG. 3B, when the text information corresponding to the user's question “When is ABC Fold coming out?” is input, the first neural network model 10 may obtain the plurality of keywords “ABC”, “Fold”, “release”, “announce”, and “expect”.

Meanwhile, the first neural network model 10 may obtain the importance values for the respective keywords based on frequencies that the plurality of obtained keywords are respectively used in the database. For example, referring to FIG. 3B, the first neural network model 10 may obtain “0.92”, “0.91”, “0.42”, “0.14”, and “0.08” as the importance values for the respective keywords based on the frequencies that the plurality of keywords “ABC”, “Fold”, “release”, “announce”, and “expect” are respectively used in the database.

As described above, when the plurality of keywords and the importance values for the respective keywords are obtained, the first neural network model 10 may output the plurality of obtained keywords and the importance values for the respective keywords and input these to the second neural network model 20.

The second neural network model 20 according to the disclosure may refer to a neural network model for outputting at least one search word to be input to the search engine 30 among the plurality of keywords. The second neural network model 20 may include a pointer network, but the structure of the second neural network model 20 according to the disclosure is not particularly limited.

Specifically, the second neural network model 20 may be trained based on the database described above. The second neural network model 20 may identify the number of keywords to be included in at least one search word among the plurality of keywords, and identify at least one search word among the plurality of keywords according to the identified number. In other words, the second neural network model 20 may determine whether the inputting a number of keywords among the plurality of obtained keywords is able to increase a probability of obtaining a search result including the answer to the user's question, and identify at least one search word to be input to the search engine 30 among the plurality of keywords according to the determined result.

Particularly, the second neural network model 20 may arrange the plurality of keywords according to the order of importance values, and identify the number of keywords by identifying a keyword having a lowest importance value among at least one keyword to be included in at least one search word through a pointer network included in the second neural network model 20.

For example, the plurality of keywords “ABC”, “Fold”, “release”, “announce”, and “expect” are obtained and “0.92”, “0.91”, “0.42”, “0.14”, and “0.08” are obtained as the importance values for the respective keywords, respectively, the second neural network model 20 may arrange the plurality of keywords in the order of “ABC”, “Fold”, “release”, “announce”, and “expect” according to the order of importance values. The second neural network model 20 may identify that “release” among the at least one keyword to be included in the at least one search word is a keyword having a lowest importance value, and identify that the number of the at least one keyword to be included in the at least one search word is three. The process of identifying the number of keywords by identifying the keyword having a lowest importance value among the at least one keyword to be included in the at least one search word through the pointer network will be described below with reference to FIG. 5.

As described above, when the at least one search word to be input to the search engine 30 is identified, the electronic device 100 may output the identified search word and input the search word to the search engine 30.

The search engine 30 may refer to an engine for performing search according to a predetermined search algorithm to obtain a search result related to an input search word in a pre-constructed search database. The search engine 30 according to the disclosure may be provided through the external server of the electronic device 100, but the type of the search engine 30 according to the disclosure is not particularly limited.

For example, referring to FIG. 3B, when at least one search word “ABC”, “Fold”, and “release” is input, the search engine 30 may output a search result “The recent foreign news reported that X Company will hold media briefing in June to announce the release date of “ABC Fold” and it will be released as early as July. But, according to the sub-contractor of Samsung Electronics, the media briefing and the official release date are not fixed yet”.

As described above, when the search result related to the user's question is obtained, the electronic device 100 may provide an answer corresponding to the user's question based on the obtained search result. For example, referring to FIG. 3B, when the search result is obtained, the electronic device 100 may provide an answer “The ABC Fold is expected to be released in July, 2019” based on the obtained search result. Herein, the point that the answer corresponding to the user's question may be provided not only in a form of the voice signal through the speaker, but also provided in a form of the visual information through the display has been described above with reference to FIG. 2B.

According to various embodiments of the disclosure described above, the electronic device 100 may obtain the plurality of keywords and the importance values for the respective keywords based on the text information corresponding to the user's question, identify at least one search word among the plurality of keywords, and obtain the search result based on the at least one identified search word, thereby providing an answer to the user's question with a high accuracy.

Particularly, according to the disclosure, even if the user inputs a question with a low probability of searching for a document including an answer to the user's question, in a case where a sentence included in the user's question is input to the search engine 30 as it is, the electronic device 100 may obtain a plurality of keywords capable of increasing a probability of obtaining a search result including an answer to the user's question by using the trained first neural network model 10, and identify an appropriate number of search words capable of increasing the probability of obtaining a search result including an answer to the user's question by using the trained second neural network model 20.

Accordingly, the user of the electronic device 100 may obtain the search result including the answer to the user's question without trial and error of repeating the process of confirming the search result, then selecting the plurality of keywords again to obtain the search result including the answer to the question, and selecting an appropriate number of search words therefrom.

Particularly, in the related art, a process of, when the text information corresponding to the user's question is obtained, obtaining a plurality of keywords based on a rule by including a subject and excluding a predicate among a plurality of words included in the text information has been performed, but according to the first neural network model 10 of the disclosure, a plurality of keywords corresponding to the user's intent may be obtained as output values with the normalized various rules according to the technology of the related art, and not only the words included in the text information, but also the words not included in the text information may be obtained as the plurality of keywords based on the database used in the training of the neural network model.

In addition, the process of selecting the appropriate number of search words among the plurality of keywords may be changed depending on various factors such as the number of plurality of keywords, the importance values for the respective keywords, and the search database used in the search engine 30, and accordingly, the electronic device 100 according to the disclosure may output the appropriate number of search words as output values with the normalized various factors described above by using the trained second neural network model 20.

In addition, as will be described below, at least one of the first neural network model 10 and the second neural network model 20 according to the disclosure may be subjected to reinforcement learning based on the search result obtained through the search engine 30, and accordingly, this may be considered as pre-training of a method for increasing a probability of obtaining the search result including the answer to the user's question by trial and error that the user may experience in the process of directly selecting the search words.

FIG. 4 is a diagram specifically illustrating a process of, when a user's voice corresponding to a user's question is received, processing the received user's voice and inputting the user's voice to the first neural network model 10 according to an embodiment.

Referring to FIG. 4, according to an embodiment of the disclosure, when a user's voice corresponding to a user's question is received, the user's voice may be input to the first neural network model 10 through the processing process of an ASR model 410 and a word embedding model.

The automatic speech recognition (ASR) model 410 may refer to a model which performs speech recognition for a user's voice. In addition, the ASR model 410 may include an acoustic model (AM), a pronunciation model (PM), a language model (LM), and the like.

The AM may extract acoustic features of the received user's voice and obtain a phonemic sequence. The PM may include a pronunciation dictionary (pronunciation lexicon), and may map the obtained phonemic sequence to a word to obtain a word sequence. The LM may designate a probability to the obtained word sequence. In other words, the ASR model 410 may obtain a text corresponding to the user's voice through the artificial intelligence model such as the AM, the PM, and the LM. Meanwhile, the ASR model 410 may include an end-to-end speech recognition model obtained by combining constituent elements of the AM, the PM, and the LM as a single neural network.

According to an embodiment of the disclosure, the text information corresponding to the user's question may be not only the text information received by a text input of the user, but also text information obtained based on a voice signal received as a voice signal by user's utterance. When the voice signal corresponding to the user's question is received, the electronic device may obtain the text information corresponding to the user's voice through the ASR model 410.

The word embedding model 420 may refer to a model which converts the text information into a vector and may be simply referred to as an encoder. Herein, the word embedding may refer to conversion of a word included in the text information into a dense vector, and specifically to a process of vectorising the meaning of the word so as to reflect a similarity between words and the like. The dense vector output through the word embedding model 420 may refer to an embedding vector.

The type of the word embedding model 420 according to the disclosure is not particularly limited, and may be implemented as one of models such as Word2Vec, Global Vectors for Word Representation (GloVe), and Bidirectional Encoder Representations from Transformers (BERT). Particularly, the BERT may refer to a model capable of obtaining an embedding vector for each word in consideration of bidirectional context of each word.

According to an embodiment of the disclosure, the electronic device does not input the text information corresponding to the user's question as it is, but may convert the text information into an embedding vector corresponding to the text information and input the embedding vector to the first neural network model 10. Specifically, when the text information corresponding to the user's question is received, the electronic device may input the received text information to the word embedding model 420 to obtain the embedding vector corresponding to the text information, and input the obtained embedding vector to the first neural network model 10.

FIG. 4 illustrates a case where the user's voice corresponding to the user's question is received, but the text information input to the word embedding model 420 may be not only the text information received by the text input of the user, but also the text information obtained based on the voice signal received in a form of the voice signal by the user's utterance.

As described above, the text information corresponding to the user's voice may be converted into the embedding vector through the word embedding model 420 to be input to the first neural network model 10. However, for convenience of description in describing the disclosure, it is described that the text information corresponding to the user's question is input to the first neural network model 10, by assuming that the text information corresponding to the user's question includes a vector sequence corresponding to the text information.

When the embedding vector corresponding to the text information is input to the first neural network model 10, the first neural network model 10 may obtain the plurality of keywords and the importance values for the respective keywords based on the database including the plurality of questions and answers to the plurality of questions. The process in which the first neural network model 10 obtains the plurality of keywords and the importance values for the respective keywords has been described above with reference to FIGS. 3A and 3B, and therefore the overlapped description will not be repeated.

FIG. 5 is a diagram specifically illustrating a processing process of the second neural network model 20 according to an embodiment.

Referring to FIG. 5, when the plurality of keywords and the importance values for the respective keywords are input, the second neural network model 20 may output at least one search word to be input to the search engine 30 among the plurality of keywords. The second neural network model 20 may include a pointer network and the second neural network model 20 may identify at least one search word to be input to the search engine 30 among the plurality of keywords through the pointer network.

The pointer network may refer to a model which outputs a position corresponding to an input column by applying a recurrent neural network (RNN) using an attention mechanism. While the RNN may not process a problem of a change of the number of output classes according to a length of the input column, the pointer network may process the problem of a change of the number of output classes according to a length of the input column.

The pointer network may use an attention mechanism based on an RNN encoder-decoder model. Specifically, the pointer network may determine an attention weight for input by using a hidden state of the encoder and a hidden state of the decoder generated so far, and output a probability for each position of the input column according to the attention weight.

Particularly, according to an embodiment of the disclosure, the second neural network model 20 may identify the number of keywords to be included in the at least one search word among the plurality of keywords, and identify the at least one search word among the plurality of keywords according to the identified number. More specifically, the second neural network model 20 may arrange the plurality of keywords according to the order of the importance values, and identify a keyword having a lowest importance value among the at least one keyword to be included in the at least one search word through the pointer network included in the second neural network model 20, to identify the number of keywords.

For example, referring to FIG. 5, when the plurality of keywords “ABC”, “Fold”, “release”, “launch”, and “announce” and “0.92”, “0.91”, “0.42”, “0.14”, and “0.08” as the importance values for the respective keywords, respectively, are input, the second neural network model may arrange the plurality of keywords in the order of “ABC”, “Fold”, “release”, “launch”, and “announce” according to the order of importance values. The second neural network model 20 may obtain a probability for each position of the input column according to the attention weight through the pointer network, and identify “release” among “ABC”, “Fold”, “release”, “launch”, and “announce” which are the plurality of input keywords, as the keyword having a lowest importance value among the at least one keyword to be included in the at least one search word. If “release” among the plurality of input keywords is identified as a keyword having a lowest importance value among the at least one keyword to be included in the at least one search word, it may be identified that the number of keywords to be included in the at least one search word is three. Accordingly, among the plurality of keywords, “ABC”, “Fold”, and “release” may be identified at least one search word to be input to the search engine 30.

As described above, when the at least one search word to be input to the search engine 30 is identified, the electronic device 100 may obtain the search result related to the user's question by inputting the at least one identified search word to the search engine 30.

Meanwhile, hereinabove, referring to FIGS. 3A to 5, it is described by assuming that each of the ASR model, the word embedding model 420, the first neural network model, the second neural network model 20, and the search engine 30 according to the disclosure is implemented as separate models, but at least two of the ASR model, the word embedding model 420, the first neural network model, the second neural network model 20, and the search engine 30 may be implemented as an integrated model.

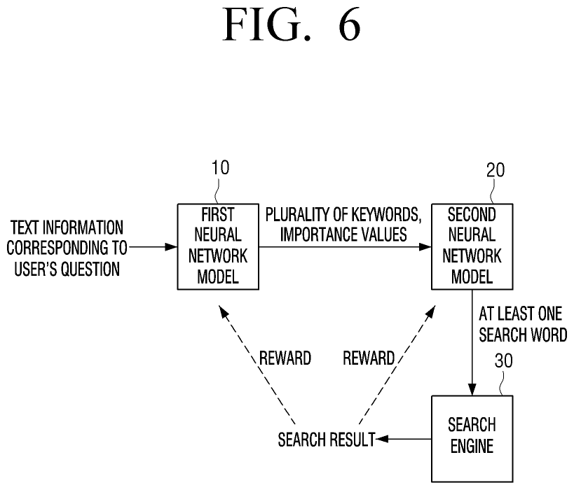

FIG. 6 is a diagram specifically illustrating a training process of the first neural network model 10 and the second neural network model 20 according to an embodiment.

At least one of the first neural network model 10 and the second neural network model 20 according to the disclosure may be trained by machine learning. The method for machine learning may be widely divided into methods of supervised learning, unsupervised learning, semi-supervised learning, and reinforcement learning.

The supervised learning may refer to a method for training a neural network model, in a state where a label which is an explicit correct answer for data is given, and the unsupervised learning may refer to a method for training a neural network model in a form of data in a state where a label for data is not given. An example of the unsupervised learning may include a clustering method for clustering types of data distributed randomly with the similar features.

Meanwhile, the reinforcement learning may refer to a method for training so that an agent which is an action agent of the training is able to perform an action for maximizing a reward. In other words, the reinforcement learning is not leaning in a state where the label is given as in the supervised learning, but may pass through the process of training the action for maximizing the reward with the trial and error.

Particularly, at least one of the first neural network model 10 and the second neural network model 20 according to the disclosure may be trained through the reinforcement learning. In other words, the at least one of the first neural network 10 and the second neural network model 20 may be trained to perform the action for maximizing the reward.

In the reinforcement learning according to the disclosure, the action may refer to an action of the first neural network model 10 for obtaining and outputting the plurality of keywords and the importance values for the respective keywords, and an action of the second neural network model 20 for identifying and outputting at least one search word among the plurality of keywords.

In the reinforcement learning according to the disclosure, the reward may be obtained based on the search result obtained through the search engine 30 based on at least one search word. Specifically, the reward may be calculated based on whether the answer to the user's question is included in at least one document of a plurality of documents included in the search result, a search order of the document including the answer to the user's question, and the like.

Referring to FIG. 6, as described above, the first neural network model 10 may obtain and output the plurality of keyword information and the importance values for the respective keyword information based on the text information corresponding to the user's question. The second neural network model 20 may identify and output at least one search word based on the plurality of keyword information and the importance values for the respective keyword information. The search engine 30 may obtain and output the search result based on the at least one search word.

Herein, the search result may include a plurality of documents arranged according to the search order. At least one of the first neural network 10 and the second neural network model 20 may be subjected to reinforcement learning based on whether the answer to the user's question is included in at least one document of a plurality of documents, and the search order of the at least one document including the answer to the user's question. In other words, the first neural network model 10 may be trained so as to output the plurality of keyword information and the importance value so that the answer to the user's question is included in a plurality of documents and included in a document with the higher search order among the plurality of documents, and the second neural network model 20 may be trained so as to output at least one search word so that the answer to the user's question is included in a plurality of documents and included in a document with the higher search order among the plurality of documents.

Hereinabove, as described above, at least one of the first neural network model 10 and the second neural network model 20 according to the disclosure may be subjected to reinforcement learning based on the search result obtained through the search engine 30, and accordingly, this may be considered as pre-training of a method for increasing a probability of obtaining the search result including the answer to the user's question by trial and error that the user may experience in the process of directly selecting the search words.

Meanwhile, hereinabove, the reinforcement learning of the first neural network model 10 and the second neural network model 20 has been described above, but the ASR model and the word embedding model 420 described above may also be subjected to the reinforcement training by the same method as the first neural network model 10 and the second neural network model 20. In addition, entire pipeline through the ASR model, the word embedding model 420, the first neural network model 10, the second neural network model 20, and the search engine 30 according to the disclosure may be trained by the end-to-end method.

Meanwhile, hereinabove, the reinforcement training has been described, but the first neural network model 10 and the second neural network model 20 may be trained through the supervised training. Specifically, the first neural network model 10 and the second neural network model 20 may be trained based on the database including the plurality of questions and the answers to the plurality of questions. In other words, the first neural network model 10 and the second neural network model 20 may be subjected to supervised learning in a state where the label which is the answer to the plurality of questions is given, so as to obtain the plurality of keywords and the importance values for the respective keywords, and identify at least one search word among the plurality of keywords, respectively, to be used in the electronic device 100.

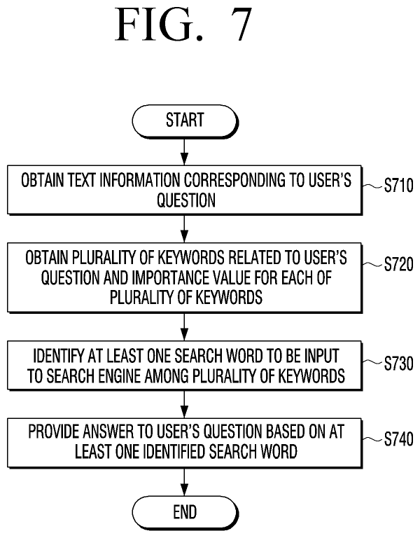

FIG. 7 is a flowchart illustrating a method for controlling the electronic device 100 according to an embodiment.

Referring to FIG. 7, the electronic device 100 according to an embodiment of the disclosure may obtain text information corresponding to a user's question (S710). The text information corresponding to the user's question may be not only the text information received by a text input of the user, but also text information obtained based on a voice signal received as a voice signal by user's utterance.

When the text information corresponding to the user's question is obtained, the electronic device 100 may obtain a plurality of keywords related to the user's question and importance values for the respective keywords (S720). Specifically, the electronic device 100 may obtain the plurality of keywords and the importance values for the respective keywords by inputting the text information corresponding to the user's question to the first neural network model. The plurality of keywords may include not only the first word included in the text information corresponding to the user's question, but also the second word which is not included in the text information corresponding to the user's question. The second word may be a word positioned in a predetermined distance from the first word among the plurality of words included in the database.

More specifically, when the text information corresponding to the user's question is input, the first neural network model may obtain a word included in the database among words included in the input text information as the first word. The first neural network model may obtain a word which is not included in the text information corresponding to the user's question but is positioned within the predetermined distance from the first word among the plurality of words included in the database as the second word.

When the plurality of keywords and the importance values for the respective keywords are input, the electronic device 100 may identify at least one search word to be input to the search engine among the plurality of keywords (S730). Specifically, the electronic device 100 may input the plurality of keywords and the importance values for the respective keywords to the second neural network model to identify at least one search word to be input to the search engine among the plurality of keywords. Particularly, the electronic device 100 may identify the number of keywords to be included in at least one search word among the plurality of keywords and identify at least one search word among the plurality of keywords according to the identified number through the second neural network model. In other words, the second neural network model may determine whether the inputting of a number of keywords among the plurality of obtained keywords is able to increase a probability of obtaining a search result including the answer to the user's question, and identify at least one search word to be input to the search engine among the plurality of keywords according to the determined result.

Particularly, the second neural network model may arrange the plurality of keywords according to the order of importance values, and identify the number of keywords by identifying a keyword having a lowest importance value among at least one keyword to be included in at least one search word through a pointer network included in the second neural network model.

When at least one search result is obtained, the electronic device 100 may provide an answer to the user's question based on the at least one identified search word (S740). Specifically, the electronic device 100 may obtain the search result related to the user's question by inputting the at least one identified search word to the search engine, and provide the answer to the user's question based on the obtained search result.

Meanwhile, the method for controlling the electronic device 100 according to the embodiment may be implemented as a program to be provided in the electronic device 100. Particularly, the program including the method for controlling the electronic device 100 may be stored and provided in a non-transitory computer readable medium.

Specifically, in the non-transitory computer readable medium including the program for executing the method for controlling the electronic device 100, the method for controlling the electronic device 100 includes obtaining text information corresponding to a user's question, obtaining a plurality of keywords related to the user's question and importance values for the respective keywords by inputting the text information corresponding to the user's question to a trained first neural network model, identifying at least one search word to be input to a search engine among a plurality of keywords by inputting the plurality of keywords and the importance value to a trained second neural network model, and providing an answer to the user's question based on the at least one identified search word.

The non-transitory computer-readable medium is not a medium storing data for a short period of time such as a register, a cache, or a memory, but may refer to a medium that semi-permanently stores data and is readable by a machine. Specifically, the various applications or programs described above may be stored and provided in the non-transitory computer-readable medium such as a CD, a DVD, a hard disk drive, a Blu-ray disc, a USB, a memory card, and a ROM.

Hereinabove, the method for controlling the electronic device 100 and the computer-readable recording medium including the program for executing the method for controlling the electronic device 100 have been briefly described, but this is for not repeating the overlapped description, and the various embodiments of the electronic device 100 may be applied to the method for controlling the electronic device 100 and the computer-readable recording medium including the program for executing the method for controlling the electronic device 100.

Each of the elements (e.g., a module or a program) according to various embodiments of the disclosure described above may include a single entity or a plurality of entities, and some sub-elements of the abovementioned sub-elements may be omitted or other sub-elements may be further included in various embodiments. Alternatively or additionally, some elements (e.g., modules or programs) may be integrated into one entity to perform the same or similar functions performed by respective element prior to the integration.

Operations performed by a module, a program, or other elements, in accordance with various embodiments, may be performed sequentially, in a parallel, repetitive, or heuristically manner, or at least some operations may be performed in a different order, omitted, or may add a different operation.

In this disclosure, the term “unit” or “module” may include a unit implemented with hardware, software, or firmware and may be interchangeably used with terms, for example, logic, logic blocks, parts, or circuits. The “unit” or the “module” may be a part integrally formed or a minimum unit or a part of the part performing one or more functions. For example, the module may be implemented as an application-specific integrated circuit (ASIC).

Various embodiments of the disclosure may be implemented as software including instructions stored in machine (e.g., computer)-readable storage media. The machine is a device which invokes instructions stored in the storage medium and is operated according to the invoked instructions, and may include an electronic device 100 (e.g., electronic device 100) according to the disclosed embodiments.

In a case where the instruction is executed by a processor, the processor may perform a function corresponding to the instruction directly or using other elements under the control of the processor. The instruction may include a code made by a compiler or a code executable by an interpreter.

The machine-readable storage medium may be provided in a form of a non-transitory storage medium. Here, the “non-transitory” storage medium is tangible and may not include signals (e.g., electromagnetic wave), and this term does not distinguish that data is semi-permanently or temporarily stored in the storage medium. For example, the “non-transitory storage medium” may include a buffer temporarily storing data.

According to an embodiment, the methods according to various embodiments disclosed in this disclosure may be provided in a computer program product. The computer program product may be exchanged between a seller and a purchaser as a commercially available product. The computer program product may be distributed in the form of a machine-readable storage medium (e.g., compact disc read only memory (CD-ROM)) or distributed online (e.g., downloading or uploading) through an application store (e.g., PlayStore™) or directly between two user devices (e.g., smartphones). In a case of the on-line distribution, at least a part of the computer program product (e.g., downloadable app) may be at least temporarily stored or temporarily generated in a machine-readable storage medium such as a memory of a server of a manufacturer, a server of an application store, or a relay server.

Meanwhile, the functions related to the ASR model, the word embedding model 420, the first neural network model, the second neural network model, and the search engine described above (hereinafter, collectively referred to as an artificial intelligence model) may be performed through the memory and the processor.

The processor may be formed of one or a plurality of processors. The one or the plurality of processors may be a general-purpose processor such as a CPU, an AP, or the like, a graphic dedicated processor such as a GPU, a VPU, or the like, or an artificial intelligence dedicated processor such as an NPU, or the like.

The one or the plurality of processors may perform control to process the input data according to a predefined action rule stored in the non-volatile memory and the volatile memory or an artificial intelligence model. The predefined action rule or the artificial intelligence model is formed through training.

Being formed through training herein may, for example, imply that a predefined action rule or an artificial intelligence model for a desired feature is formed by applying a learning algorithm to a plurality of pieces of training data. Such training may be performed in a device demonstrating artificial intelligence according to the disclosure or performed by a separate server and/or system.

The artificial intelligence model may include a plurality of neural network layers. Each layer has a plurality of weight values, and executes processing of the layer through a processing result of a previous layer and processing between the plurality of weight values. Examples of the neural network may include convolutional neural network (CNN), a deep neural network (DNN), recurrent neural network (RNN), restricted Boltzmann machine (RBM), deep belief network (DBN), bidirectional recurrent deep neural network (BRDNN), and deep Q-network, but the neural network of the disclosure is not limited to the above examples, unless otherwise noted.

The learning algorithm may be a method for training a predetermined target machine (e.g., robot) by using a plurality of pieces of training data to allow the predetermined target device to determine or predict by itself. Examples of the learning algorithm include supervised learning, unsupervised learning, semi-supervised learning, or reinforcement learning, but the learning algorithm of the disclosure is not limited to the above examples, unless otherwise noted.

While preferred embodiments of the disclosure have been shown and described, the disclosure is not limited to the aforementioned specific embodiments, and it is apparent that various modifications can be made by those having ordinary skill in the technical field to which the disclosure belongs, without departing from the gist of the disclosure as claimed by the appended claims. Also, it is intended that such modifications are not to be interpreted independently from the technical idea or prospect of the disclosure.

What is claimed is:

1. An electronic device comprising:
a memory storing at least one instruction; and
a processor configured to execute the at least one instruction,
wherein the processor, by executing the at least one instruction, is configured to:
obtain text information corresponding to a user's question;
obtain a plurality of keywords related to the user's question and importance values for the respective keywords by inputting the text information corresponding to the user's question to a trained first neural network model;
identify at least one search word to be input to a search engine among the plurality of keywords by inputting the plurality of keywords and the importance values to a trained second neural network model; and
provide an answer to the user's question based on the at least one identified search word.

2. The device according to claim 1,
wherein the first neural network model is configured to obtain the plurality of keywords and the importance values based on a database comprising a plurality of questions and answers to the plurality of questions, and
wherein the plurality of keywords comprise a first word included in the text information corresponding to the user's question and a second word not included in the text information corresponding to the user's question.

3. The device according to claim 2, wherein the second word is a word positioned within a predetermined distance from the first word among the plurality of words included in the database.

4. The device according to claim 1, wherein the second neural network model is configured to:
identify a number of keywords to be included in the at least one search word among the plurality of keywords; and
identify the at least one keyword among the plurality of keywords according to the identified number.

5. The device according to claim 4, wherein the second neural network model is configured to:
arrange the plurality of keywords according to an order of the importance values; and
identify the number of keywords by identifying a keyword having a lowest importance value among at least one keyword to be included in the at least one search word through a pointer network included in the second neural network model.

6. The device according to claim 1, further comprising:
a microphone,
wherein the processor is configured to, based on a voice signal corresponding to the user's question being received through the microphone, obtain text information corresponding to the user's question based on the voice signal.

7. The device according to claim 1, further comprising:
a communicator comprising circuitry,
wherein the processor is configured to:
control the communicator to transmit information on the at least one identified search word to a server for providing the search engine;
receive a search result for the at least one identified search word from the server via the communicator; and
provide an answer to the user's question based on the received search result.

8. The device according to claim 7, wherein at least one of the first neural network model and the second neural network model is trained based on the received search result.

9. The device according to claim 8,
wherein the search result comprises a plurality of documents arranged according to a search order, and
wherein at least one of the first neural network model and the second neural network model is subjected to reinforcement learning based on whether the answer to the user's question is included in at least one document of the plurality of documents, and the search order of the at least one document.

10. The device according to claim 9, wherein an entire pipeline of the first neural network model and the second neural network model is subjected to reinforcement learning by an end-to-end method.

11. A method for controlling an electronic device, the method comprising:
obtaining text information corresponding to a user's question;
obtaining a plurality of keywords related to the user's question and importance values for the respective keywords by inputting the text information corresponding to the user's question to a trained first neural network model;
identifying at least one search word to be input to a search engine among the plurality of keywords by inputting the plurality of keywords and the importance values to a trained second neural network model; and
providing an answer to the user's question based on the at least one identified search word.

12. The method according to claim 11,
wherein the first neural network model is configured to obtain the plurality of keywords and the importance values based on a database comprising a plurality of questions and answers to the plurality of questions, and
wherein the plurality of keywords comprise a first word included in the text information corresponding to the user's question and a second word not included in the text information corresponding to the user's question.

13. The method according to claim 12, wherein the second word is a word positioned within a predetermined distance from the first word among the plurality of words included in the database.

14. The method according to claim 11, wherein the second neural network model is configured to:
identify a number of keywords to be included in the at least one search word among the plurality of keywords; and
identify the at least one search word among the plurality of keywords according to the identified number.

15. A computer-readable recording medium comprising a program for executing a method for controlling an electronic device, the method comprising:
obtaining text information corresponding to a user's question;
obtaining a plurality of keywords related to the user's question and importance values for the respective keywords by inputting the text information corresponding to the user's question to a trained first neural network model;
identifying at least one search word to be input to a search engine among the plurality of keywords by inputting the plurality of keywords and the importance values to a trained second neural network model; and
providing an answer to the user's question based on the at least one identified search word.
